(19) United States
(12) Patent Application Publication
(10) Pub. No.: US 2023/0012276 A1
(43) Pub. Date: Jan. 12, 2023

(54) System, Method, and Apparatus for Decentralized E-Commerce

(71) Applicant: Instantgo, Inc., Los Angeles, CA (US)

(72) Inventor: Nathanael Eisenberg, Los Angeles, CA (US)

(21) Appl. No.: 17/369,134

(22) Filed: Jul. 7, 2021

(51) Int. Cl. G06Q 20/36; G06Q 20/38; G06Q 30/06

(52) U.S. Cl. CPC G06Q 20/363; G06Q 20/389; G06Q 30/0641; G06Q 2220/00

(57) ABSTRACT

A system, method, and apparatus for decentralized e-commerce and related transactions are provided. A computing system is configured to generate buyer and seller digital wallets on a distributed ledger, receive listings for products sales from a seller electronic device, display listings for sale, and receive requests to purchase any of the listings from a buyer electronic device. A computing system is configured to chain a new block of data to a previous block of related data each time an inquiry, transaction, or other interaction with data contained with a digital wallet, such as currency or product or service listings, are received. The computing system is further operative to authenticate, display, and even translate communications transmitted and received by and between buyer/seller user electronic devices.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT AND TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to commerce conducted over the Internet, and more particularly to a decentralized online marketplace configured to eliminate third party management and supervision of commercial exchanges between buyers and sellers as well as authenticate the exchanges themselves.

### BACKGROUND

Since the turn of the 21st century, and with thanks to technological improvements in communications carried out over the Internet, commerce has dramatically shifted on-line. Much of this commerce takes place on centralized online platforms, such as, but not limited to, Amazon®, Alibaba.com, and DHgate.com, which serve as single points of control over relationships between transacting parties. They keep track of, manage, and ultimately control all accounts and balances and further serve as the point of contact in case of disputes. In exchange for non-governmentally providing these management-type services, these platforms hold their buyer and seller users to various operational, non-negotiable rules and conditions in which the centralized platforms give themselves the power to remove product listings, suspend buyer and/or seller accounts, and even freeze access to funds. These seemingly unforgiving and even severe results of centralization occur out of necessity: individualizing moderation of buyer/seller engagement across billions of transactions in “e-commerce” is truly a gargantuan task.

In addition to the disadvantages to moderation noted above, there are a number of additional drawbacks for buyer and seller users of centralized e-commerce platforms. For instance, many of the platform rules and conditions are enforced dispassionately by software bots and even underqualified contractors. When disputes arise, enforcers frequently lack—and take no effort to gain—particular knowledge of the products or services at issue, as well as geo and culturally-specific nuance that might color such disputes. As another example, features like which currency may be used in transactions and geographic distribution areas may be limited or dictated by the centralized platforms. As still another example, public reviews and feedback from buyers are frequently considered untrustworthy in spite of the fact that they are often personally identifiable because sellers' desires for high volume sales and visibility incentivizes them to plant or buy or otherwise inflate positive reviews.

Some have proposed solutions to address these and other problems associated with centralized online marketplaces and e-commerce. For instance, U.S. patent Ser. No. 11/010,811 to Rosenfeld et al., for instance, teaches centralizing an online marketplace featuring competitor merchants in order to glean improved market data about buyer behavior. U.S. Pat. No. 8,224,727 by Hirson et al. teaches transactions based on social networking in an attempt to increase trust in commerce by enabling users to engage in transactions directly with their friends and friends-of-friends. U.S. Pat. Pub. No. 2015/0170112 by DeCastro teaches transacting in two or more currencies in the field of commercial, online banking. U.S. Pat. Pub. No. 2015/0019384A1 by Fabian et al. teach software modules for users to purchase products directly from manufacturers and related logistics. Still, these have not sufficiently addressed the problems, and there remains a need for an online marketplace that is secure and reliable for both buyers and sellers while minimizing involvement from third-party intermediaries.

### SUMMARY

The present disclosure is directed to decentralized online marketplaces in which goods and services may be exchanged directly between users on a networked platform. More particularly, a system, method, and apparatus are provided for an online marketplace—or “e-commerce platform”—operating on a distributed ledger, such as a blockchain, and configured to immutably execute and authenticate commercial transactions that occur directly between buyer and seller users. Certain aspects of the invention discussed herein render the online marketplace accessible to any potential buyer or seller; maintain ownership of data stored in digital wallets, including currency and product and service listings, with any potential buyer or seller owner of such wallets; and eliminate middlemen that have traditionally, extra-governmentally moderated relationships and activities on e-commerce platforms.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, a computing system is configured to generate a digital wallet which is itself operative to store and manage the wallet owner's data on a distributed ledger. This data may comprise one or more fiat currencies, cryptocurrencies, native assets, fungible tokens, non-fungible tokens, transaction records and receipts, communication logs, access logs, physical inventory listings, virtual inventory listings, service listings, biographical and other personally identifying information, pending and settled contracts, and government-issued licenses, among others.

In some embodiments, the digital wallet is a non-custodial wallet controlled and owned entirely by a particular user of the system, such as a buyer or a seller user. In such embodiments, the computer system is configured so that data contained within the wallet are accessible, and therefore divestible, only upon confirmation by private key associated with the wallet. That is, the system is configured to transmit data from one wallet to another upon receiving authorization from such wallet. In order to complete a transaction between digital wallets, such as by sending currency from one wallet for goods or services listed for sale in another digital wallet, the computing system is operative to digitally approve the transaction. It may be appreciated, then, that the system enables transactions to occur between the parties only, independent of any third-party verification or other moderation.

It is contemplated that each time any transaction involving the digital wallet occurs, a record of the transaction is made on the distributed ledger. In one embodiment, the distributed ledger is a blockchain, and the computing system generates a new, immutable chain memorializing the transaction on the blockchain. In some exemplary embodiments, a transaction may comprise a sale or transfer of goods or services. In some embodiments, a transaction may comprise an inquiry regarding contents of a wallet, such as physical or virtual product inventory. In some embodiments, a transaction may comprise Thus, it may be seen that a “transaction” may be any activity at all involving data stored in a particular wallet.

It should be noted that maintaining data ownership and recording transactions in this manner has a number of beneficial effects. In one exemplary embodiment, fraudulent transactions and related disputes between buyers and sellers are reduced when the system records data characterizing each transaction on the e-commerce platform on the distributed ledger since such data is irrevocably stored with reference to a user's digital wallet.

Likewise, it is contemplated that manipulation and deception frequently associated with product and service reviews in centralized e-commerce platforms may be curtailed by certain embodiments of the system for decentralized e-commerce. For instance, the computing system may be operative to receive and/or display product or service reviews exclusively from prior buyer users whose bona fide transactions with seller users have been immutably stored, and thus verified as authentic, on the distributed public ledger. As a result, a prospective buyer may be empowered by the system to more accurately assess a seller's reliability as well as, for instance, the quality of goods and or services offered. Indeed, in some embodiments, the computing system may be operative to reflect additional useful, crowdsourced, and authenticated information, such as whether a review was solicited or edited, since such actions may be immutably hashed and publicly accessible on the exemplary blockchain. Indeed, the system may be even further operative to qualify users as trusted—or distrusted—buyers, as the case may be.

It is also contemplated that the computing system may be configured to verify and/or authenticate the origin of goods and services offered for sale on the distributed public ledger in a similar manner.

In some embodiments, operations comprising the system, method, and apparatus for decentralized e-commerce reduce or even eliminate involvement from third parties to commercial transactions and in turn reduces certain risks of exposing sensitive information. For instance, verified buyer-to-seller wallet-to-wallet transactions contemplated by the system occur in the absence of third-party payment processors. This reduces the number of information transfers and intermediate opportunities for theft of buyer and seller data in the process of finalizing a transaction. This effective data shield in turn reduces any need for third-party transaction monitoring and even further reduces operating costs and service fees associated with the expense that centralized online marketplaces charge sellers to monitor and/or moderate interactions, including transfer of payments, within their digital stores.

The computing system may be further operative to geo-locate its members, which further enables them to filter one another by their respective locations. In an embodiment, this ensures that, for example, decentralized system may be operative to reveal locally-relevant demographics, enabling sellers to exercise marketing efforts more efficiently in terms of which products they offer for sale, where, and for what price. In some embodiments, this functionality may even influence which fiat or virtual currency, fungible or non-fungible tokens, or other assets stored as data in their digital wallet they choose to accept or pay for goods and/or services offered for sale. That is, in one embodiment, the computing system may be configured to receive a selection of seller or buyer-accepted cryptocurrency, fiat money, or any other supported token.

In some embodiments, the computing system may be configured to receive and transmit written and/or audio communications directly between buyers and sellers without third-party intervention or moderation. Direct engagement in this manner may be beneficial for preventing and resolving disputes, improving customer service and marketing efficacy, and even supporting product and service development. Indeed, it is contemplated that supporting direct communication in this manner may ultimately result in fewer economic losses which may have previously been attributable to generalized moderation resulting from the sheer breadth of activity occurring in traditional, centralized online marketplaces. In some embodiments, the system may even be configured to enable direct pursuit and settlement of commercial exchanges within such direct communications, or chats, rather than, or in addition to, accessing product or service listings through a digital storefront. For instance, in some embodiments, the system may be configured to receive and transmit communications between buyer and seller users in a chat display or messaging interface, or other means for facilitating direct, electronic communication between parties. In such chats, the system may be configured to transmit and receive user messages directed to products and services that may be for sale to some extent as well as set and agree upon certain terms of a commercial exchange. In such embodiments, buyer and seller user transactions may be accessible directly within a chat or message interface, enabling users to buy, sell, or otherwise transact within an online marketplace. Such transactions may be chained on any blockchains exiting within such chats, obviating user need to navigate to an additional or external interface to perform such actions.

Of course, these communications, and any others, may be authenticated or preserved on their own or an existing blockchain.

The computing system may be further configured to receive a seller, or buyer as the case may be, choice of currency at least partially defining terms of a transaction. For instance, it is contemplated that this may empower a seller to offer a physical or virtual product or service for the price and in exchange for the currency of their choice. That is, the computing system may be configured to display a price for a product or service as defined by regular fiat money for the region where a seller or buyer is domiciled, fiat money for a targeted region or regions, or any of innumerable cryptocurrencies of the seller's choice. As such, according to one embodiment, the system is operative to receive a selection of preferred currency type, as well as convert and display any price listed in fiat money for any region to its concurrent cryptocurrency equivalent.

In view of the foregoing, it is one object of the invention to facilitate online commerce between buyers and sellers of goods and services.

It is another object of the invention to minimize third-party management and/or supervision of online commercial transactions between parties.

It is another object of the invention to maintain ownership of data with such users themselves.

It is yet another object of the invention to immutably authenticate transactions between buyers and sellers in an online marketplace.

It is an object of the invention to foster confidence and trust amongst members in an online marketplace.

It is another object of the invention to provide electronic means for storing virtual items such as and including currency and fungible and non-fungible tokens exchangeable within the online marketplace for goods and services.

It is another object of the invention to facilitate and authenticate self-executing contracts formalizing commercial transactions in an online marketplace.

It is another object of the invention to facilitate hyper-local commercial exchange of goods and services in an online marketplace.

It is yet another object of the invention to facilitate global commercial exchange of goods and services in an online marketplace.

It is still another object of the invention to facilitate online commerce between buyers and sellers who communicate in different languages from one another.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 is a block diagram of a networked environment in which an exemplary embodiment of a system for decentralized e-commerce is implemented.

FIG. 2 illustrates an exemplary embodiment of a mobile device shown in FIG. 1.

FIG. 3 is a flowchart illustrating an exemplary embodiment of a method for decentralized e-commerce.

FIG. 4 is a flowchart illustrating an exemplary embodiment of a method for decentralized e-commerce.

The disclosed embodiments may be better understood by referring to the figures in the attached drawings, as provided below. The attached figures are provided as non-limiting examples for providing an enabling description of the method and system claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

The present invention, in some embodiments, may comprise a decentralized electronic database distributed across various computers, or “nodes.” Full, lightweight (or simply “light”) nodes, client and submitting-client, peer, endorser, orderer, and/or ordering-service nodes are collectively referred to herein as “nodes” unless otherwise specified. The decentralized database may securely store and transmit data between computers, other electronic devices, and/or one or more nodes. The present invention may provide that when a new data record, such as any of the various transactions disclosed herein, is created, it may link to the user's previous data record in the manner known in the block chain database art by using the storage information and chain-creation logarithms or instructions within the data record. By way of non-limiting example, the “genesis” block of a particular blockchain may contain a hash comprising its time and date of creation, at least one element of data (content, usage, rights data or cryptocurrency ownership) and a computer-solvable problem that, when solved, allows another block to link to the present block. Similarly, all other blocks on the blockchain in question may then comprise the previous block's hash, a hash comprising that block's time and date of creation, at least one element of data (content, usage, rights data or cryptocurrency ownership) and a computer-solvable problem that, when solved, allows another block to link to the present block.

In some embodiments, the present invention contemplates a separate blockchain for a cryptocurrency ledger that records cryptocurrency transfers and ownership data, content of all types (thereby ensuring the content's integrity), and content usage by users. In some embodiments, the present invention may process data from one type of blockchain (i.e. usage) and cause a change in one or more other blockchains (i.e. may record a related cryptocurrency transfer on the cryptocurrency ledger blockchain). In some embodiments, any blockchain may comprise any combination of data types. For example, a storefront in an online marketplace may comprise a blockchain containing product listings and ownership data within the data blocks. In some embodiments, the storefront in an online marketplace may comprise a separate blockchain for authenticating communications data, such as chats between sellers and prospective buyers seeking product and service information.

In some embodiments, the present invention may utilize one or more storefronts and one or more cryptocurrency systems and ledgers in tandem or in combination.

By creating a linked series of immutable data records, the present invention may provide a secure chain of data records. As discussed more fully herein, the chain information may comprise one or more cryptographic hashes. For example, if the second data record contains the first data record's hash, the link between the two may be verified. By creating a new hash for each data record, and including that hash in the second data record, the present invention may provide for a traceable chain of data records.

The present invention may use real-world objects such as data matrix codes (or quick response “QR” codes) as private keys that “unlock” or decrypt a set of data when a user scans the QR code if desired. A non-limiting application of this may be a physical “wallet” bearing a QR code that corresponds to a user's cryptocurrency account.

In some embodiments, a node may be any suitable electronic device, such as but not limited to a server, a mobile device, or desktop computer, that is linked to one or more networks provided by the present invention and that may perform the functions of the present invention, such as storing, linking block-to-block (“chaining” and thereby creating a link in a blockchain), encrypting, decrypting, and transmitting data. Each node may be configured to independently and automatically verify, update, link, and store each record.

The exemplary blockchain database of the present invention may utilize various cooperative or decentralized computing principles. In some embodiments, the blockchain database may utilize principles or techniques drawn from cloud computing, thin-cloud computing, fog computing, or even “blockcloud” computing. The present invention may provide that the software, systems, methods, applications, computer programs, and so forth required to execute one or more instructions, methods, computer programs, or functions of the present invention may be stored on nodes, a cloud, thin cloud, fog, or blockcloud server structure.

The present invention may also provide for one or more interface elements, such as by way of illustration and not limitation, a desktop software program, a mobile application, or a website, that enables the user or, in some embodiments, a member of the public, to view one or more elements of a data record. By way of illustration and not limitation, a website may host an interface, wherein a login action could take a user to an individual's webpage. On the webpage, the present invention may describe or link to one or more elements of the individual's data record. By way of illustration and not limitation, such a page may contain a randomized identifier, the present data record's hash, a link to the data record's previous hash, and one or more links to one or more elements of user-specific data. In some embodiments, when viewed by a member of the general public, the webpage and the data record information may be hidden, randomized, or otherwise unreadable. Or in some embodiments, when viewed by a member of the general public, the webpage and the data record information may be deidentified but otherwise viewable. In some embodiments, when “unlocked” via the QR code, the data record may display unencrypted versions of the user-specific data, along with the hashes.

The present invention may comprise some elements of traditional block chain database encryption, storage, management, and access. The present invention may also make use of other, more widely-used technologies, such as cloud computing, emails, and text messages. The present invention may also draw upon, digitize, or otherwise incorporate paper documents in some embodiments.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

The present disclosure is directed to a system, method, and apparatus for online decentralized e-commerce, that is, an online commercial platform and means for exchanging goods and services directly between user buyers and seller.

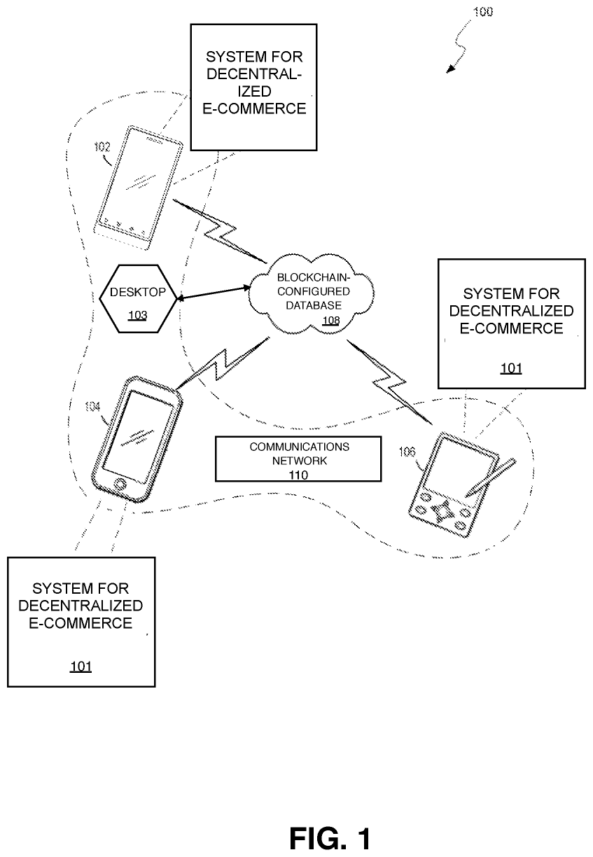

FIG. 1 illustrates an exemplary embodiment of a system, method, and apparatus for decentralized e-commerce 100 which includes a plurality of electronic devices communicatively coupled to one another. By way of example, and not limitation, FIG. 1 illustrates mobile devices 102, 104, and 106, and desktop computer 103 that incorporate a system for decentralized e-commerce 101 and may be communicatively coupled via a communications network 110 and exemplary blockchain-configured database 108. Each of the mobile devices 102, 104, and 106 may be embodied as a mobile computing device such as, for example and without limitation, a smartphone or tablet computer that incorporates cellular telephone functionality. Notably, the communications network 110 may use one or more of various communications types such as, for example and without limitation, short range device-to-device wireless data transfer (i.e. Bluetooth), cellular, and Wi-Fi communications. In some embodiments, one or more nodes (not pictured) may take the place of one or more of mobile devices 102, 104, and 106, and desktop computer 103. Communications network 110 may serve to communicatively couple, link, or transfer data between one or more of mobile devices 102, 104, and 106, desktop computer 103, and any node with blockchain-configured database 108.

Users of desktop computer 103 and mobile devices 102, 104, and 106 may be users of at least one blockchain-configured database 108 known to those skilled in the art. For instance, as noted above, blockchain-configured database 108 may comprise a peer-to-peer network, a cloud-based computing network, a fog computing network, a blockcloud computing network, or any other blockchain-configured database 108 known in the art capable of secure or unsecure data transfer. In some embodiments, blockchain-configured database 108 may be facilitated by a website that may require a registration and login prior to use.

In one embodiment, a data record may be stored in multiple copies across blockchain-configured database 108 on one or more nodes. While not separately pictured, any of one or more of mobile devices 102, 104, and 106, and desktop computer 103 may serve as one or more nodes. In some embodiments, each node may contain and run the software, hardware, firmware, or any other component, necessary to run the present invention. More specifically, each node may provide for a computer system that may run the program of the present invention, create, store, and link (or “chain”) data records to other data records. Each node may also provide for computational power sufficient to perform hash functions, other one-way encryption functions, two-way encryption functions, public key encryption functions and programs, symmetric encryption and symmetric key encryption functions and programs, along with any other function that may be used or provided for by the present invention.

In brief, the original or “genesis” data record may comprise, at least, a hash that records a timestamp representing the data record's creation date and time (along with, in some embodiments, other information), encrypted user-specific data, and instructions for the linking of the second data record to the present data record. In some embodiments, the instructions may comprise a mathematical problem to be solved. In some embodiments, the present invention may provide that the solution is provided to one or more nodes in blockchain-configured database 108. In some embodiments, some or all of the nodes in blockchain-configured database 108 may be equally able to solve the instructions, and therefore some or all of the nodes may discover the solution at roughly the same time, thus ensuring uniformity of record-keeping across blockchain-configured database 108. Additional data records may be linked to the genesis data record, and may comprise a new timestamp hash unique to that data record, the previous data record's hash, encrypted updated user-specific data, and instructions for the next block as detailed elsewhere herein.

Blockchain-configured database 108 may also be configured to associate a data record, and user-specific data within the data record, with a QR code. In some embodiments, the QR code may be stored on any or several of desktop computer 103 and mobile devices 102, 104, and 106. In some embodiments, the QR code may be displayed on at least one of desktop computer 103 and mobile devices 102, 104, and 106. The QR code thus displayed may be scanned by at least one of desktop computer 103 and mobile devices 102, 104, and 106, or by a different scanning device such as a hand-held scanner configured to work with the present invention (not pictured).

In some embodiments, the present invention may provide that one or more of desktop computer 103 and mobile devices 102, 104, and 106 may serve as a first electronic device. In such a configuration, one or more of desktop computer 103 and/or mobile devices 102, 104, and 106 may be configured to display a QR code. The QR code may, in some embodiments, be used as a user's private key and may, when scanned from the display of the first electronic device, cause the present invention to unlock, decrypt, or otherwise permit access to one or more items of user-specific data.

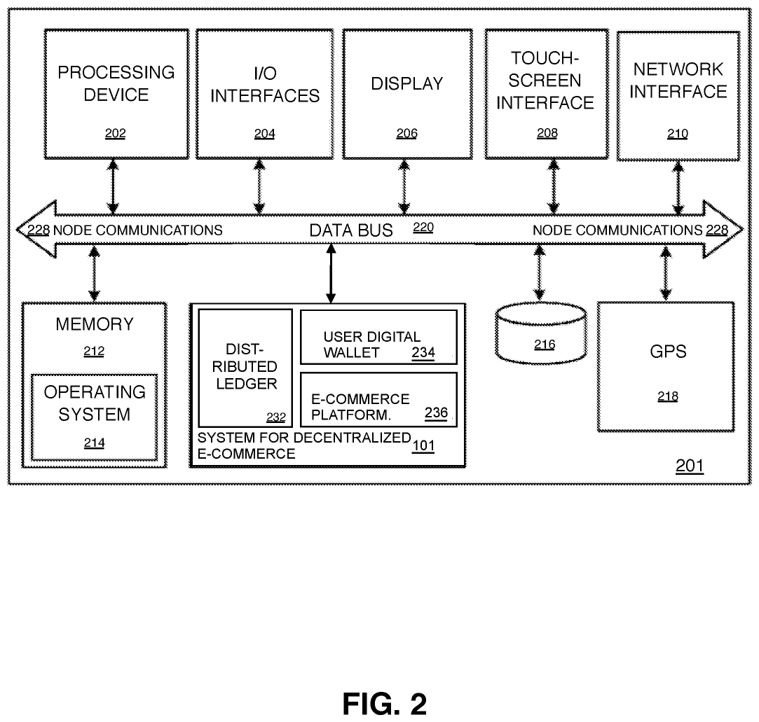

FIG. 2 illustrates an exemplary electronic device configured to serve as a node 201 in the system for decentralized e-commerce. The node 201 may comprise, at least, at least one processing device (processor) 202, at least one input/output interface 204, at least one display 206, at least one user interface 208, at least one network interface 210, at least one memory 212, at least one operating system 214, at least one mass storage 216 and at least one GPS 218, with each communicating across a local data bus 220. FIG. 2 also discloses the relationship of local data bus 220, the distributed ledger 232 (or, collectively “data blocks”), the digital rights management tool 234, and the online content platform 236 of system for decentralized e-commerce 101. In some embodiments, node 201 may communicate with other node(s) 228 via one or more networks (not shown in FIG. 2). Additionally, an individual QR code (not pictured) may act as a private key that may enable one or more nodes 201 to access blockchain-encrypted data in an unencrypted or deidentified, or both, form.

As the present invention contemplated a distributed ledger computer system wherein each node 201 may communicate with one or more nodes 201, and in some embodiments all other nodes 201, one or more elements of node 201 may be absent in any particular node 201 or shared across one or more nodes 201. In some embodiments, while it is contemplated that, generally although not required in every case, each node 201 may store a copy of all cryptocurrency data blocks 232 and their block-chains across the entire present invention, thereby creating a network of secure computing systems and thorough redundancy, one or more other elements may be partially stored on one or more nodes 201, or stored on one node 201 but accessed by another node 201. By way of illustration and not limitation, memory 212 and/or operating system 214 may be partially stored across several nodes 201 but accessed by multiple nodes 201, or may be stored on one or more nodes 201 and accessed by nodes 201 that do not have their own memory 212 and/or operating system 214.

The processing device 202 may include any custom made or commercially available processor, a central processing unit (CPU) or an auxiliary processor among several processors associated with node 201, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 212 may include any one of a combination of volatile memory elements (e.g., random-access memory (RAM, such as DRAM, and SRAM, etc.)) and nonvolatile memory elements. The memory typically comprises native operating system 214, one or more native applications, emulation systems, or emulated applications for any of a variety of operating systems and/or emulated hardware platforms, emulated operating systems, etc. For example, the applications may include application specific software which may comprise some or all the components of node 201. In accordance with such embodiments, the components are stored in memory and executed by the processing device. Note that although depicted separately in FIG. 2, the system, method, and apparatus for decentralized e-commerce 100 may be resident in memory such as memory 212. As mentioned above, in some embodiments, one or more nodes 201 may not have their own memory 212 and/or operating system 214 or may store incomplete memory 212 and/or operating system 214, and may therefore draw upon other nodes 201 for use of one or more memory units 212 and/or operating system elements 214 via node 201 to node 201 communication 228, as discussed herein.

User interface 208 may be configured to detect contact within the display area of the display 206 and may provide such functionality as on-screen buttons, menus, keyboards, etc. that allows users to navigate user interfaces by touch. User interface 208 may also be a keyboard, a mouse, a microphone, a vision tracking system, a motion-capture system, a trackball, or any other known interface with a computing system. For some embodiments, node 201 may also comprise GPS 218 or other means to determine the location of the node 201.

One of ordinary skill in the art will appreciate that the operating system 214 can, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIG. 2, network interface device 210 comprises various components used to transmit and/or receive data over a networked environment such as depicted in FIG. 1. When such components are embodied as an application, the one or more components may be stored on a non-transitory computer-readable medium and executed by the processing device.

In some embodiments, data blocks stored on the distributed ledger 232 may be stored in one language, generally the user's native language. In some embodiments, however, the present invention may provide, through memory 212 or any other element of the present invention including elements known to the art but not disclosed in FIG. 2, that the data blocks on the distributed ledger 232 may be translated into a selected language by an end user. For example, the present invention may provide that data blocks on the distributed ledger 232 may be stored in English, but when accessed by a user, by using one or more of mobile device(s) 201, 104, 106 or desktop computer 103 to access data blocks via QR code, the data blocks may be translated into the language of the accessing device, here mobile device(s) 201, or 104, 106 or desktop computer 103 of FIG. 1. This change may be automated in some embodiments, and may enable users to globally review and appreciate data blocks authenticating their transactions.

Storage information for the exemplary blockchain elements of the present invention, which may encompass all the data for the present invention, as discussed in more detail herein, is generally managed as a series of links or “chains” between blocks, wherein each link to the chain requires a mathematical problem to be solved. Once a node 201 has reached the solution, the next block may be linked or chained to the present cryptocurrency data blocks block 232, thus creating the “blockchain” known in the art. Such chaining may comprise, in some embodiments, recording the hash of a first cryptocurrency data blocks 232 in or on a second cryptocurrency data blocks 232. In some embodiments, therefore, the chain may be traced by examining the corresponding hashes of each cryptocurrency data blocks 232 to make sure that they match as intended.

Continuing with FIG. 2, the genesis cryptocurrency data block 232 may provide for only one hash that may comprise a timestamp (at least) hash of its creation. For all other cryptocurrency data blocks 232, hash(s) may comprise a timestamp (at least) hash of the creation of the present cryptocurrency data block 232 as well as the hash of the previous cryptocurrency data block 232. Thereafter, each cryptocurrency data block 232 may comprise, at least, one or more hash(s), one or more items of cryptocurrency data, and one or more elements of storage information or chaining information. In some embodiments, an identical copy of each cryptocurrency data block 232 may be stored on one or more nodes 201. In some embodiments, an identical copy of each cryptocurrency data block 232 may be stored on each node 201.

In embodiments wherein the contents of the digital wallet 234 associated with a system user, such as a buyer or a seller, content and content interaction information (“content” for brevity) is stored in blockchain form, similarly, the genesis content block 234 may provide for only one hash that may comprise a timestamp (at least) hash of its creation. For all other content blocks generated from alteration of the content 234, hash(s) may comprise a timestamp (at least) hash of the creation of the present content block 234 as well as the hash of the previous content block 234. Thereafter, each content block 234 may comprise, at least, one or more hash(s), one or more items of content data, and one or more elements of storage information or chaining information. In some embodiments, an identical copy of each content block 234 may be stored on one or more nodes 201. In some embodiments, an identical copy of each content block 234 may be stored on each node 201.

Remaining with FIG. 2, the present invention may be, and is contemplated generally to be, configured such that one or more nodes 201 may communicate with each other 228. The node 201 to node 201 communication system 228 provides for and enables one or more redundancy and/or data security protections of the present invention. Using node 201 to node 201 communication system 228, one or more nodes 201 of the present invention may all update one or more cryptocurrency data blocks 232 and cryptocurrency data block 232 chains, and content blocks 234 and content block 234 chains, hashes, copies of cryptocurrency data blocks 232 or content blocks 234, and any other element that the present invention may store on a node 201. One or more nodes 201 may utilize node 201 to node 201 communication system 228 to share one or more storage information 224, thereby enabling one or more nodes to chain a new cryptocurrency data blocks 232 to a previous cryptocurrency data block 232 or a new content block 234 to a previous content block 234. Additionally, one or more nodes 201 may utilize node 201 to node 201 communication system 228 to share one or more node 201 elements, such as but not limited to, part or all of a node's 201 at least one processing device (processor) 202, at least one input/output interface 204, at least one display 206, at least one user interface 208, at least one network interface 210, at least one memory 212, at least one operating system 214, at least one mass storage 216, at least one GPS 218, and/or at least one local data bus 232.

In some embodiments, a QR code may be used by the present invention as a private key. In some embodiments, when a user scans a user's QR code, such as by way of illustration by using one or more of mobile devices 201, 104, 106 and/or desktop computer 103, the present invention may provide one or more items of cryptocurrency data blocks 232 to the user in an unencrypted form, or a form having a mixture of encrypted and intelligible cryptocurrency data blocks 232 and/or content blocks 234. In some embodiments, the user may access the full cryptocurrency data blocks 232 or content blocks 234 and a fully unencrypted or fully intelligible record of the cryptocurrency data blocks 232 or content blocks 234. In some embodiments, only one QR code may be used at a time, and in some embodiments, only by the authorized user of mobile device(s) 201, 104, 106 or desktop computer 103 who initiated access via the QR code in the first place. In some embodiments, the user's QR code may be used by more than one mobile device 201, 104, 106 or desktop computer 103 at a time. It is contemplated that the user may be able to set preferences within the present invention, or utilize a secondary document such as a wallet card, to determine who or what may utilize the user's QR code, in what manner, and to what extent.

The present invention may provide that when a QR code is utilized to access a user's cryptocurrency data blocks 232 or content blocks 234, the present invention may create a new hash within a new cryptocurrency data block 232 or content block 234 that links to the accessed cryptocurrency data block 232 or content block 234 in the manner known in the block chain database art and generally described herein. By creating a linked series of chained cryptocurrency data blocks 232 or content blocks 234, it is contemplated that the present invention may provide a secure chain of data storage and data records.

In FIG. 2, data is shown progressing in both directions between data bus 232 and cryptocurrency data blocks 232 or content blocks 234 through QR code or apart from QR code. In some embodiments, the role of QR code is one-directional, wherein a user via mobile device(s) 201, 104, 106 or desktop computer 103 may utilize QR code to access cryptocurrency data blocks 232, whereupon data bus 232 or any other element of node 201 may transfer one or more elements of cryptocurrency data blocks 232 from cryptocurrency data blocks 232 to the user's electronic device, such as but not limited to mobile device(s) 201, 104, 106 or desktop computer 103. In some embodiments, data may flow to the system for decentralized e-commerce 101 without QR code activation.

In order to facilitate the aforementioned functionality, various aspects may be performed by one or more of desktop computer 103 and/or mobile devices 201, 104, and 106, or any node 201 which may be but is not limited to desktop computer 103 and/or mobile devices 201, 104, and 106. In one embodiment, the desktop 103, mobile devices 102, 104, and 106, and/or any node 201 are operative to perform, at least in part, any method or system disclosed herein. Any of desktop 103, mobile devices 102, 104, and 106 may serve as a node 201 or carry out one or more node 201 functions.

Moreover, as discussed above, any element of content comprising the digital wallet 234 may be stored on the present invention's distributed ledger or blockchain database in the same manner as any other data block on the distributed ledger 232. These could include physical or virtual goods, transaction receipts, shipping logs, communications logs, reviews, licenses, and/or contracts, among others.

In some embodiments, the present invention may provide that a user may use his or her QR code or other access element, such as a login on a webpage or to an application, to view one or more content 234 elements. Moreover, each time content in the digital 234 is viewed or accessed, the present invention may update the blockchain for that particular content 234, per the block creation and chaining mechanisms detailed above. Content 234 and a corresponding content block may therefore be interchangeable, as each content 234 stored in the user digital wallet 234 may be stored as a content block.

Additionally, data blocks on the distributed ledger 232 and content 234 may interface. For example, were a user to purchase or some product listing comprising content in a seller-user's digital wallet 234 with some cryptocurrency acceptable to the parties, the content blocks 234 and, in some embodiments, a separate cryptocurrency data blocks may be updated accordingly. The present invention contemplates that any transaction involving content 234 and any other data blocks may be recorded in the appropriate distributed ledger, such as block chain(s) and/or blockchain database.

Attention is now turned to one or more blockchain-related elements of the present invention. The blockchain paradigm provides a generalized framework for implementing decentralized computer resources. Each computing resource may be thought of as a singleton state-machine that may transition between states via cryptographically-secured transactions. When generating a new state-machine, the nodes encode logic which defines valid state transitions and uploads it onto the blockchain. From there on, the blocks may journal a series of valid transactions that, when incrementally executed with the state from the previous block, morph the state-machine into its current state. In a public chain, the Proof of Work consensus algorithm and its underlying peer-to-peer protocol secure the state-machines' process and transitioning logic from being tampered, and also share this information with all nodes participating in the system. Nodes may, therefore, query the state machines at any time and obtain a result which is accepted by the entire network with high certainty. This transaction-based state-machine generalization of the blockchain is informally referred to as smart contracts.

Ethereum is one example of an attempt at a full implementation of this idea, which may be known to those skilled in the art. The present invention is not limited to Ethereum, and Ethereum is used herein merely as an illustrative and non-limiting embodiment. Any equivalent(s) or substitution(s) for Ethereum is/are contemplated. Indeed, cryptocurrency native to the system for decentralized e-commerce is contemplated.

In its present form, Ethereum builds into the blockchain a Turing-complete instruction set to allow smart-contract programming and a storage capability to accommodate on-chain state. The flexibility of its programming language may be an important property in the context of rights management. This property may enable advanced functionality (multi-party arbitration, bidding, reputation, etc.) to be coded into the present system, adapting to comply with differences in regulation and changes in stakeholders needs. The present invention may utilize Ethereum's smart contracts to create intelligent representations of commercial contracts that are stored within individual nodes on the network. The present invention may construct the contracts to contain metadata about the contractual terms, permissions, and data integrity. The blockchain transactions in the present system may carry cryptographically signed instructions to manage these properties. The contract's state transition functions may carry out policies and enforce data alternation only by legitimate transactions. Such policies may be designed to implement any set of rules which govern particular terms, as long as the policy may be represented computationally. For example, a policy may enforce that separate transactions representing both offer and acceptance are transmitted and received by the system from both buyer users and seller users before transferring ownership of goods and/or services between the parties.

Cryptocurrencies may be generally thought of as digital currency systems that are run on a blockchain and utilize a blockchain financial ledger. The present invention's cryptocurrency is contemplated to exist as a coin or token that has an assigned value based on its purchase in a cryptocurrency marketplace of the present invention. The assigned value may change based on any number of factors, including but not limited to investor valuation, market conditions, supply, reserve, demand, exchange rates, and so forth.

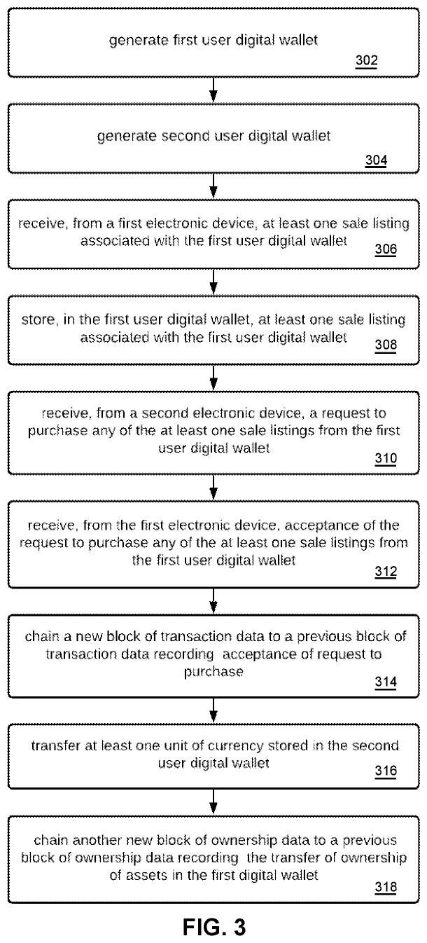

FIG. 3 generally discloses a flowchart depicting an exemplary embodiment of a method for decentralized e-commerce. In the embodiment shown, a computing system is configured to generate a first and second user digital wallet 302, 304. The first and second user may be, for example only and not limitation, a seller user and a buyer user, respectively. Then, the computing system may receive from an electronic device associated with the first exemplary seller user at least one sale listing associated with the seller digital wallet and storing such listing as data in the seller digital wallet 306. The computing system may be configured to display such listings 308 for view by prospective buyer and/or other seller users of the system for decentralized e-commerce. Then, the computing system is configured to receive, from an electronic device from another user, such as a buyer user, a request to purchase any of the at least one sale listings from the buyer digital wallet 310. The computing system is further configured to receive, from the seller electronic device, acceptance of the request to purchase any of the at least one sale listings from the buyer digital wallet 312 and chain a first new block of transaction data to a previous block of transaction data, wherein the first new block of transaction data records the acceptance of the request to purchase any of the at least one sale listings 314. The computing system is then further configured to transfer at least one unit of currency, or another asset agreed upon by the parties, stored in the buyer digital wallet to the seller digital wallet 316, and chain a first new block of ownership data to a previous block of ownership data, wherein the first new block of ownership data records the transfer of assets in the first digital wallet 318.

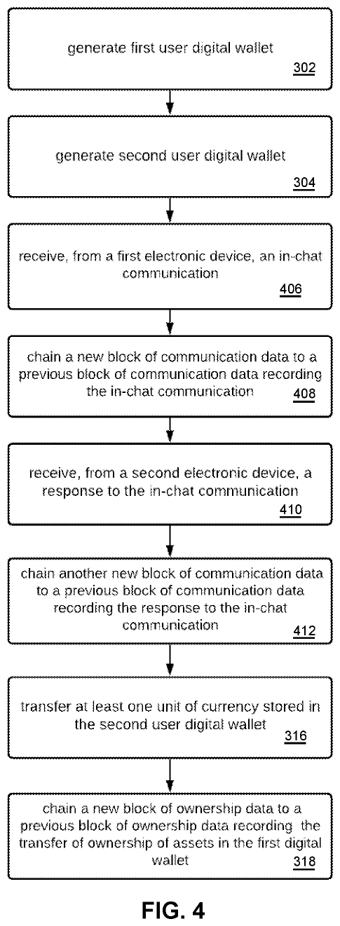

In another embodiment, the computing system may be configured to facilitate transactions directly between users within a chat, messaging, or other communication interface. In addition to providing a store front comprising one or more listings associated with a seller user's wallet, it is contemplated that users may transact with one another outside of such storefronts via one or more chat, messaging, or other communication interfaces. In some embodiments, the parties' commercial contract to buy or sell goods and/or services may comprise a self-executing smart contract as discussed above. Thus, as shown in FIG. 4 and in accordance with one embodiment of the invention, a computing system may be configured to generate a first and second user digital wallet 302, 304; receive, from a first electronic device, an in-chat communication 406; chain a new block of communication data to a previous block of communication data recording the in-chat communication 408; receive, from a second electronic device, a response to the in-chat communication 410; and chain another new block of communication data recording the response to the in chat communication to a previous block of communication data 412. The in-chat communication may of course be directed to an offer to buy or sell goods, including details such as price and other terms. In such cases, the computing system may be configured to finalize a commercial transaction, as before. More particularly, the computing system may be configured to transfer at least one unit of cryptocurrency stored in the second user digital wallet 316 and chain a new block of ownership data to a previous block of ownership data, recording the transfer of ownership of assets in the first digital wallet 318. These assets may be listings of physical assets, which could then be delivered in physical form to the buyer user according to terms agreed upon by the parties, or virtual assets which could be immediately, imminently, or at some agreed-upon time, transferred from a seller user digital wallet to a buyer user digital wallet.

The system, method, and apparatus for decentralized e-commerce 100 may provide for a proprietary cryptocurrency configured to be utilized by the online content platform of the present invention. The cryptocurrency may be supported by a distributed online ledger stored according to blockchain computing principles across one or more nodes. In some embodiments, the cryptocurrency may be a token or token, or referred to as a coin or token. The users of the system, method, and apparatus for decentralized e-commerce 100 may trade cryptocurrency for physical goods, virtual goods, or certain services stored or represented by data stored in seller users' digital wallets. In some embodiments, tokens may be traded for or representative of fiat money.

In other words, the users of the system, method, and apparatus for decentralized e-commerce 100 may be able to trade the cryptocurrency directly with other users, from wallet-to-wallet, or redeem the cryptocurrency for goods and services, or in some embodiments, monetary currency or a real-world item or benefit. Goods and services contemplated may include, for instance only and not limitation, physical goods and products including home goods, personal care items, food stuffs, clothing, appliances, machinery, among any other innumerable items that may be bought or sold. Goods and services contemplated may also include, for instance only and not limitation, virtual goods such non-fungible tokens including electronic tickets and other verifiable digital assets. A user may also in some embodiments use the cryptocurrency to purchase contracts for services, licenses, and even intellectual property rights such as distribution rights.

To illustrate a sequence involving the present invention's cryptocurrency and cryptocurrency reward system, a three-user example may be instructive. In some embodiments, a first user may become a member of the present invention's network, and cryptocurrency for the first user may be allocated to the user 301. The first user also receives a wallet, and in some embodiments, a first installment of the present invention's cryptocurrency (or more simply, “cryptocurrency”). By becoming a member, the first user receives unlimited access to content which enables the user to view content within the seller's generated wallet. This may be, for example, product or service listings as well as pricing, delivery and location information that may be found in a traditional brick and mortar or centralized online storefront.

In some embodiments, the present invention may further provide for a digital or real wallet within which a user may store cryptocurrency or cryptocurrency-identifying information, such as a QR code. In some embodiments, a person may purchase the cryptocurrency with any real world or “hard” currency, such as but not limited to dollars or euros.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system, method, and apparatus for decentralized e-commerce with which that terminology is associated. In general, the terms used in the following claims should not be constructed to limit the system, method, and apparatus for decentralized e-commerce to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the system, method, and apparatus for decentralized e-commerce is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the system, method, and apparatus for decentralized e-commerce.

What is claimed is:

1. A system for a decentralized e-commerce platform, comprising:
by a computing system:
generating, on a distributed ledger, at least one digital wallet associated with a seller;
generating, on the distributed ledger, at least one digital wallet associated with a buyer;
receiving, from a first electronic device, and storing in the seller digital wallet, at least one sale listing associated with the seller digital wallet;
displaying the at least one sale listing associated with the seller digital wallet;
receiving, from a second electronic device, a request to purchase any of the at least one sale listings from the buyer digital wallet;
receiving, from the first electronic device, acceptance of the request to purchase any of the at least one sale listings from the buyer digital wallet;
chaining a first new block of transaction data to a previous block of transaction data, wherein the first new block of transaction data records the acceptance of the request to purchase any of the at least one sale listings;
transferring at least one unit of currency stored in the buyer digital wallet; and
chaining a first new block of ownership data to a previous block of ownership data, wherein the first new block of ownership data records the transfer of assets in the first digital wallet.

2. The system of claim 1, wherein the computing system is further configured to display written communications transmitted and received from the first or second electronic device.

3. The system of claim 1, wherein the distributed ledger is a blockchain.

4. The system of claim 1, wherein the at least one product listing for sale is selected from any of a physical product, a service, and a virtual product.

5. The system of claim 1, wherein transferring at least one unit of currency is to the seller digital wallet.

6. The system of claim 1, wherein transferring at least one unit of currency is to an escrow digital wallet configured to release funds under execution of a smart contract.

7. A non-transitory, tangible computer-readable medium having stored thereon computer-executable instructions, which, when executed by a computer processor, enable one or more computers coupled to a network to execute a method for an online content platform and related cryptocurrency, the method comprising:
by a computing system:
generating, on a distributed ledger, at least one digital wallet associated with a seller;
generating, on the distributed ledger, at least one digital wallet associated with a buyer;
receiving, from a first electronic device, and storing in the seller digital wallet, at least one sale listing associated with the seller digital wallet;
displaying the at least one sale listing associated with the seller digital wallet;
receiving, from a second electronic device, a request to purchase any of the at least one sale listings from the buyer digital wallet;
receiving, from the first electronic device, acceptance of the request to purchase any of the at least one sale listings from the buyer digital wallet;
chaining a first new block of transaction data to a previous block of transaction data, wherein the first new block of transaction data records the acceptance of the request to purchase any of the at least one sale listings;
transferring at least one unit of currency stored in the buyer digital wallet; and
chaining a first new block of ownership data to a previous block of ownership data, wherein the first new block of ownership data records the transfer of assets in the first digital wallet.

8. The computer-implemented method of claim 7, wherein the computing system is further configured to display written communications transmitted and received from the first or second electronic device.

9. The computer-implemented method of claim 7, wherein the distributed ledger is a blockchain.

10. The computer-implemented method of claim 7, wherein the at least one product listing for sale is selected from any of a physical product, a service, and a virtual product.

11. The computer-implemented method of claim 7, wherein transferring at least one unit of currency is to the seller digital wallet.

12. The method of claim 7, wherein transferring at least one unit of currency is to an escrow digital wallet configured to release funds under execution of a smart contract.

13. A system for a decentralized e-commerce platform, comprising:
by a computing system:
generating, on a distributed ledger, at least one digital wallet associated with a seller;
generating, on the distributed ledger, at least one digital wallet associated with a buyer;
receiving, from a first electronic device, an in-chat communication;
chaining a new block of communication data to a previous block of communication data recording the in-chat communication;
receiving, from a second electronic device, a response to the in-chat communication;
chaining another new block of communication data to a previous block of communication data recording the response to the in-chat communication;
transferring at least one unit of currency stored in the buyer digital wallet; and
chaining a first new block of ownership data to a previous block of ownership data, wherein the first new block of ownership data records the transfer of assets in the first digital wallet
wherein the computing system is configured to display in-chat communications received from the first and second electronic devices.

14. The system of claim 13, wherein the distributed ledger is a blockchain.

15. The system of claim 13, wherein transferring at least one unit of currency is to the seller digital wallet.

16. The system of claim 13, wherein transferring at least one unit of currency is to an escrow digital wallet configured to release funds under execution of a smart contract.
